(19) United States
(12) Patent Application Publication
(10) Pub. No.: US 2021/0237174 A1
(43) Pub. Date: Aug. 5, 2021

(54) Drill Guides With Canting Base and Dowel Jig Attachments

(71) Applicant: Charles Hadley Cammack, Lenexa, KS (US)

(72) Inventor: Charles Hadley Cammack, Lenexa, KS (US)

(21) Appl. No.: 16/949,732

(22) Filed: Nov. 12, 2020

Related U.S. Application Data
(63) Continuation-in-part of application No. 16/778,616, filed on Jan. 31, 2020.

(51) Int. Cl. B23B 49/02

(52) U.S. Cl. CPC B23B 49/023

(57) ABSTRACT

These inventions include three drill guides (Multiguide, Triguide, and Uniguide), and two attachments (canting base and dowel jig). The drill guides allow users to drill holes to prescribed depths into flat work surfaces using various sizes of twist and auger bits while eliminating marring and reducing wood splintering. The canting base attachment allows users to drill holes to prescribed depths and at variable angles into flat surfaces and both large and small cylinders having zero, one, or two free ends using various kinds and sizes of drilling tools including twist, auger, and Forstner bits. The dowel jig attachment allows users to drill dowel holes to prescribed depths in edges and faces of work pieces that are evenly spaced apart by numerous gauged distances and at infinitely adjustable distances from edges without slippage or misalignment. These inventions have drill press-like capabilities and can be used in fields and shops.

### RELATED APPLICATION

This application claims the priority benefit of U.S. Provisional Patent Application Ser. No. 62/814,170 filed Mar. 5, 2019 which is incorporated by reference herein.

This application also claims the priority benefit of U.S. Nonprovisional patent application Ser. No. 16/778,616 filed on Jan. 31, 2020 which is incorporated by reference herein.

### RELATED US PATENT DATA

All related US Patent Data known to the inventor are listed in the parent application and are incorporated by reference herein.

### FIELD OF THE INVENTION

Charles Hadley Cammack, a US citizen and resident of Lenexa, Kans. located in Johnson County has invented three new drill guide and depth-stop tools named Multiguide, Triguide, and Uniguide (hereinafter drill guides) that stem from the original drill guide invention disclosed in the parent application which has an upper and lower plate, with each plate having a multiplicity of matching, co-aligned smooth holes that serve as drill bit bushings. Smooth recesses in the bottom surface of the bottom plate of the original drill guide serve to center and align the drill guide with its original attachments which have corresponding projecting pins. This continuation-in-part application discloses that it is beneficial to replace the smooth recesses with threaded holes that can receive replaceable pins, and to replace the pins projecting from attachments with smooth recesses. The parent application includes a brief discussion of other embodiments that would serve as bushing carriers but does not include any drawings or claims related to those embodiments. The Triguide and Uniguide inventions disclosed in this continuation-in-part application serve as bushing carriers. Additionally, this application discloses new canting base and dowel jig attachments that work with the new drill guides. These new inventions increase convenience, stability, and safety.

Like the original drill guide disclosed in the parent application, the Multiguide, Triguide, and Uniguide drill guides allow users to:
drill holes to prescribed depths perpendicular to flat working surfaces with no marring and reduced splintering of wood using hand-held electric drills
drill holes to precise depths and at variable angles into flat work surfaces and both large and small cylinders using various kinds and sizes of drilling tools including twist, spade, auger, Forstner, and brad-point bits as well as countersinks, unibits, and taps
place these tools on cylinders whereas prior art requires users to place cylinders within tools
drill holes at various angles of inclination through the center of both large and small diameter cylinders and cylinders having no free end
drill dowel holes on edges and faces of work pieces that are spaced apart by various gauged distances and aligned at precise distances from work piece edges

Drill presses allow users to drill holes to precise depths and alignments in work pieces small enough to fit within them. These three new drill guides allow users to drill holes to precise depths and alignments in work pieces that are too large for drill presses and can thus be used in the field and shops.

The new drill guides can be positively secured to the new canting base attachment preventing inadvertent separation of the new drill guides from the new canting base. Users can hold a new drill guide and the new canting base as a unit with one hand while operating the drill with their other hand. Convenience, stability, and safety are increased compared to the original drill guide and original canting base disclosed in the parent application.

These three new drill guides eliminate both the need for dowel jig sliding block adapters and the potential for misalignment of dowel holes due to inadvertent adapter movement. Elimination of sliding block adapters also leads to a greatly reduced dowel jig thickness, weight, and parts count. The new dowel jig disclosed in this continuation-in-part application is easier to manufacture, safer, and more stable and convenient than the original dowel jig disclosed in the parent application.

Another great benefit of the Triguide and Uniguide is that they have replaceable bushings. These new drill guides can thus service a wide range of bushing sizes and have a long service life. An additional benefit of the Uniguide is that it can be expanded by adding segments allowing it to service both very short and very long drilling tools. Additionally, the Uniguide has a smaller footprint than the Multiguide and Triguide making it possible for users to operate the Uniguide in tighter quarters.

The Multiguide, Triguide, Uniguide, new canting base, and new dowel jig increase convenience, stability, and safety and reduce weight and complexity compared to the original inventions disclosed in the parent application.

### BRIEF SUMMARY OF THE INVENTION

### Multiguide

At first glance, the Multiguide appears to be identical to the original drill guide disclosed in the parent application as both inventions are composed of a bottom plate having a shaft with external threads interrupted by alignment grooves secured to its top center surface, a top plate that slidingly connects to the shaft, and a double nut. A multiplicity of bushing pairs (smooth holes) is formed in both plates, and alignment grooves in the shaft threads maintain correct alignment of bushing pairs. Both inventions have a locking double nut (two sets of internal threads) that secures the top plate to the shaft. However, the centering pin recess and index pin recesses in the bottom face of the bottom plate of the original drill guide are replaced by straight, threaded holes that can receive removeable center and index pins in the Multiguide. In essence, the centering pin recess and index pin recesses in the original drill guide are replaced by removeable pins, and the pins projecting upward from attachments are replaced with a centering pin recess and index pin recesses. This reversal may seem incidental and of no real value; however, the great benefits of this reversal become apparent when the new canting base and dowel jig attachment embodiments are considered.

### Triguide

The Triguide is similar to both the drill guide and Multiguide in that it has a bottom and a top plate (shaped as a triangle in this case), a shaft having threads interrupted by alignment grooves, and a double nut. However, the Triguide differs from those tools in that each plate has three large diameter, shallow threaded holes that receive threaded drill bit bushing inserts. A bushing insert having a large outside diameter and a threaded edge is installed in each threaded hole in the top of the top plate and a slightly larger bushing insert is installed in each threaded hole in the bottom of the bottom plate. The bottom bushing reduces tear out in work pieces because its bottom face bears on the working surface. The Triguide supports the use of three different bushing sizes at any one time. Like the drill guide and Multiguide, only one bushing pair can be set to the correct maximum depth of one drill bit diameter at any one time. Smaller diameter pilot holes can be drilled using other bushings provided the pilot hole does not exceed the planned maximum hole depth. Other embodiments having more or fewer bushings in each plate can readily be developed.

Triangular notches formed at each apex of the top and bottom plates are used in conjunction with the canting base attachment and drilling tools having bits that are larger than their shanks.

### Uniguide

The Uniguide differs greatly in appearance and form from the original drill guide, Multiguide, and Triguide in that it has, in its most simple form, just one body that serves as a bushing carrier. The same bushing inserts used in the Triguide can be used with the Uniguide. One threaded bushing insert is installed in a threaded hole in top of the Uniguide body and a slightly larger threaded bushing insert is installed in a threaded hole in the bottom of the body. Thus, two bushing inserts can be installed in the Uniguide body that align drill bits and also limit the depth of drilling. Long drill bits can be used with the Uniguide by attaching one or more segments to the Uniguide body and installing a bushing insert in the top-most segment. The Uniguide can be used in tighter quarters than the original drill guide, Multiguide, and Triguide, because it has a smaller footprint.

The Uniguide body and each segment includes a notch that is used in conjunction with the new canting base attachment and drilling tools having bits that are larger than their shanks. The front of the Uniguide body is beveled so that the body can be more severely canted.

### Centering and Alignment System

The Multiguide, Triguide, and Uniguide drill guides and both the canting base and dowel jig attachments employ the same centering and alignment system. A shallow threaded centering hole is formed in the center of the bottom face of all three new drill guides that can receive the threaded end of either a connecting bolt or a centering pin. Shallow threaded index pin holes are also formed at constant radial distances from the center hole in the bottom face of each drill guide that can receive threaded index pins. The number and locations of threaded index pin holes varies among the three new drilling guides.

The threaded center hole in the base of each new drill guide can receive a connecting bolt that secures the drill guide to the canting base. The centering pin, when installed in the bottom of a drill guide, extends below the bottom face of that drill guide and engages a matching recess at the center of one dowel jig sliding block.

Two index pins installed in appropriate threaded index pin holes in the base of the drill guides engage recesses in the top surface of the canting base or an individual sliding block aligning the drill guide with the attachment.

This centering and alignment system forces the Multiguide, Triguide, and Uniguide drill guides to be properly positioned and aligned with the canting base attachment and dowel jig sliding blocks.

### Canting Base Attachment

At first glance, the new canting base attachment disclosed in this continuation-in-part application appears to be identical to the original canting base attachment disclosed in the parent application. Both the original and new canting bases include a circular body having a flat top surface, a deeply grooved bottom surface, a large drill bit recess at the front of the body, and a canting shaft in a fixture at the rear of the body.

There are two important differences: 1) the center pin projecting from the top surface of the original canting base is replaced by a large, smooth hole that receives a bolt that secures the new canting base to the three new drill guides, and 2) index pins projecting from the top surface of the original canting base are replaced by recesses that conform to the replaceable index pins that are installed in the bottom surface of the three new drill guides. The great benefit is that all three new drill guides can be joined securely to the new canting base allowing users to operate them as one unit with one hand while they operate the drill with their other hand. This reversal of pin and recess locations greatly increases convenience, stability, and safety and reduces complexity and parts count.

A canting shaft installed in the fixture at the rear of the new canting base attachment allows users to cant the attachment and drill guide on both flat and cylindrical working surfaces. Canting angle graduation lines on the shaft can be used when drilling into flat working surfaces. When drilling into cylindrical surfaces, the canting shaft should be installed with the graduation lines facing left or right, not to the rear. In that case, the notch at the bottom end of the shaft will conform to the cylindrical shape. Additionally, canting angles must be measured using an external device such as a bevel square.

### Dowel Jig Attachment

The original dowel jig attachment disclosed in the parent application has one center sliding block and four outboard sliding blocks. Users shift a pin adapter from one sliding block to another before drilling a hole to align and support the original drill guide. Users must also shift blank adapters from one sliding block to another to support and stabilize the original drill guide when using the original dowel jig. The pin adapter disclosed in the parent application has a centering pin and two index pins that engage recesses in the bottom plate of the original drill guide. Blank adapters have no pins projecting upward from their top surface. All adapters move freely fore and aft so that they can easily be swapped in position. However, users must maintain a rearward force on the original drill guide while drilling to insure proper positioning of each dowel hole. The pins projecting from the top surface of the pin adapter makes this process necessary.

The new dowel jig disclosed in this continuation-in-part application has sliding blocks that have recesses rather than pins in their top surfaces. Thus, the new sliding blocks have no adapters and remain fixed in position throughout the drilling process. Users simply move the Multiguide, Triguide, or Uniguide drill guides from one sliding block to another without having to swap adapters and maintain a rearward force on the tool. The functionality of the new dowel jig is the same as the original dowel jig. However, the new dowel jig is safer and thinner, has fewer parts, is easier to produce, and more convenient compared to the original dowel jig.

Self-centering dowel jigs can only be used correctly on uniformly thick edges of work pieces having zero or two veneered or finished faces. If work pieces have only one finished or veneered face, then holes should be located at their structural centers, not their geometric centers. It is often desirable to locate dowel holes closer to one face than another to increase joint strength.

Good joinery requires that the face-to-dowel hole distance be constant and does not require that dowel holes be placed at the geometric center of work pieces. Consider a shelf supported by dowels. For reason of increased strength, dowel holes will desirably be located below the shelf's geometric center. This new dowel jig does not force users to place dowels at the geometric center of an edge. Dowel holes can be accurately located at any location including geometric and structural centers. The new drill guides and new dowel jig enable users to drill multiple dowel holes to prescribed depths in the edges and faces of work pieces that are evenly spaced apart and accurately aligned at one setup location.

Self-centering dowel jigs cannot be used on the broad faces of work pieces. Both the new and original dowel jigs can be used to drill holes into the faces of work pieces.

Like other dowel jigs, this new dowel jig must be properly positioned on an edge or face of a work piece at a first location. This new dowel jig attachment can be automatically and correctly positioned at a second location on an edge or face by simply placing it against the work piece using the last drilled hole and the work piece edge as guides. The new dowel jig is thus described as being self-aligning rather than self-centering.

The original dowel jig brace disclosed in the parent application supports the dowel jig when drilling holes in the edges of work pieces. However, the integral clamps on both the original and new dowel jig will not engage the ends of narrow work pieces. The original dowel jig brace has two curved gusset plates and must be secured to the work piece using one or more external clamps. However, points suitable for mounting of clamps are limited, and the clamping process is somewhat awkward.

The new dowel jig brace disclosed in this continuation-in-part application has only one gusset plate and provides three suitable locations for external clamps. The new dowel jig brace can readily be used to drill holes into the narrow ends of long work pieces and is much more convenient and secure than the original dowel jig brace.

With the dowel jig brace removed, the new dowel jig attachment can be placed at any location on faces of work pieces. Dowel holes for shelving can be installed that do not fully penetrate the work piece because holes will be drilled to prescribed depths. Users can clamp the new dowel jig attachment to a standard clamped to the work piece to maintain proper position and alignment.

### DESCRIPTION OF PRIOR ART

Prior art is described in the parent application and is incorporated by reference herein.

### OBJECTS AND SUMMARY OF THE INVENTION

The object of the Multiguide, Triguide, Uniguide, new canting base, and new dowel jig inventions disclosed in this continuation-in-part application is to improve upon the convenience, stability, and safety provided by the inventions disclosed in the parent application. These improvements come about largely by reversing the positions of pins and matching recesses among the new drill guides and attachments. Though seemingly a trivial change, it leads to great improvements in convenience, stability, and safety when the new drill guides are used in conjunction with the new canting base and dowel jig attachments. In particular, the new canting base can be securely attached to the drill guides and sliding block adapters are not needed with the new dowel jig.

The parent application includes a thorough discussion of the objects and summary of the original drill guide and its attachments. The objects and summary of the inventions disclosed in this continuation-in-part application are very similar to the objects and summary of the present inventions.

Many existing depth-stop tools can limit hole depth but cannot align drilling tools perpendicular to working surfaces or at various prescribed angles relative to working surfaces. Some tools serve to align bits perpendicular to working surfaces but cannot limit hole depth unless used in combination with other tools. Many existing depth-stop tools rotate when they contact working surfaces marring them. Most depth-stop tools do not reduce splintering of wood. Most depth-stop tools only support the use of drilling tools that have bits and shanks of the same diameter. One drilling tool maintains the tool perpendicular to flat working surfaces and limits hole depth, but only supports tools that have bits larger in diameter than their shanks (one shank size). Additionally, it is necessary to remove the drilling tool from the depth-stop and alignment tool to change bits. This device also requires long drilling tools.

It is therefore an object of the present invention to allow users to drill holes to prescribed depths that are aligned normal to work surfaces without marring and with reduced splintering of wood using drilling tools having bits that are the same size or larger than their shanks.

Some depth-stop tools can be used to drill through the center of small cylindrical objects placed in them but cannot be used on large diameter pipes or on installed pipes having no free ends. It is an object of this invention to allow users to drill holes to prescribed depths through the center of large and small cylindrical objects in both shops and fields, and at variable inclinations, even if they have no free ends. A further object of these inventions is to provide a tool assembly that can be controlled with just one hand.

No existing depth-stop tools that attach to twist bits can be used with drilling tools having bits larger in diameter than their shanks. Many existing depth-stop tools are formed as a collar that is secured to bits using a set screw that can be easily lost and which requires a tool for operation. Set screws must bear on the lands of bits to work properly and to avoid damaging drill tools. Another kind of collar fits several sizes of bits, but has an appreciable length reducing the maximum depth of drilling for a given bit length and increasing the required length of drilling tools. Other depth-stop tools are disposable, lack precision, or deform during use changing depth control

It is an object of this invention to allow users to align drilled holes perpendicular to work surfaces and to control the depth of drilling when using drilling tools having bits that are larger than their shanks and to eliminate the need for supplemental tools and fasteners.

Self-centering dowel jigs cannot be used to drill dowel holes in the faces of flat work pieces. In addition, self-centering is not desired when work pieces have only one finished or veneered face, or when drilling dowel holes for miter joints. It is therefore an object of this invention to permit users to drill evenly spaced-apart holes to specific depths into edges of work pieces that are located at constant distances from work piece edges.

It is a further object of this invention to allow users to drill evenly spaced-apart dowel holes in the faces of work pieces.

It is an object of this invention to allow users to drill dowel holes for multiple bit diameters and variable spacings including standard spacings.

It is an object of this invention to allow the creation of both blind and through miter joints.

It is an object of this invention to allow users to secure the Multiguide, Triguide, or Uniguide to the canting base so that they become a unit that users can control with one hand while operating a drill with their other hand.

It is a further object of this invention to eliminate the need for users to swap out pin adapters for blank adapters while drilling dowel holes.

It is a further object of this invention to provide a dowel jig brace that allows users to more conveniently and safely clamp the dowel jig to narrow work pieces.

### BRIEF DESCRIPTION OF THE FIGURES

Figures showing the preferred embodiment of the invention are briefly described as follows:

FIG. 1 depicts a vertically exploded Multiguide viewed from above.

FIG. 2 depicts the assembled Multiguide viewed from above.

FIG. 3 depicts the assembled Multiguide viewed from below.

FIG. 4 depicts the vertically exploded Triguide viewed from below

FIG. 5 depicts the assembled Triguide viewed from above.

FIG. 6 depicts the assembled Triguide viewed from below.

FIG. 7 depicts the vertically exploded Uniguide viewed from above.

FIG. 8 depicts the assembled Uniguide viewed from above.

FIG. 9 depicts the assembled Uniguide with one segment attached as viewed from below.

FIG. 10 depicts a top-rear view of the new canting base attachment.

FIG. 11 depicts a bottom-front view of the new canting base attachment.

FIG. 12 depicts the assembled dowel jig attachment viewed from above.

FIG. 13 depicts the assembled dowel jig attachment viewed from below.

FIG. 14 depicts a top-front view of the center sliding block.

FIG. 15 depicts a bottom-rear view of the center sliding block.

FIG. 16 depicts a top-front view of an outboard sliding block.

FIG. 17 depicts a bottom-front view of an outboard sliding block.

FIG. 18 depicts a top-front view of the dowel jig brace.

FIG. 19 depicts a bottom-rear view of the dowel jig brace.

FIG. 20 depicts an exploded view of a Uniguide set up with lifting components.

### DETAILED DESCRIPTION OF PREFERRED EMBODIMENT

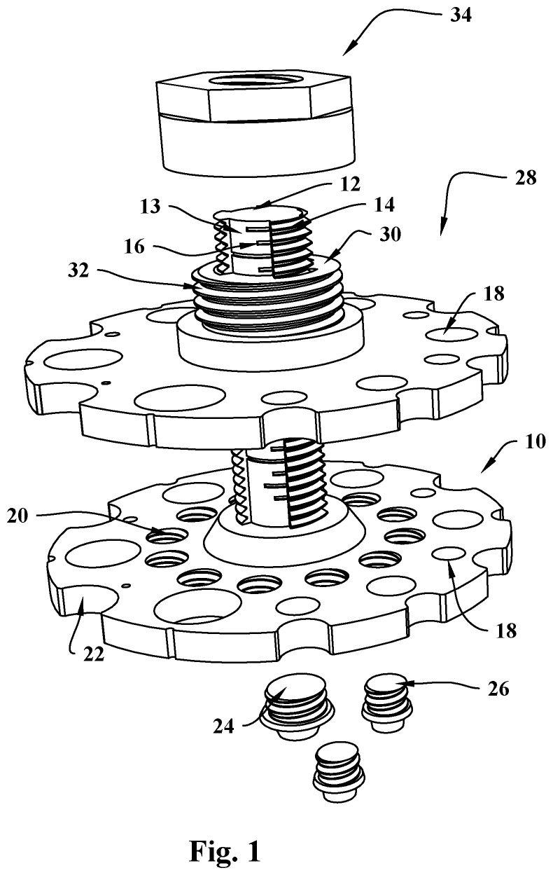

FIG. 1 shows the three primary components of the Multiguide (bottom plate 10, top plate 28, and double nut 34) in an exploded view. The bottom plate has a shaft 12 extending upward from the center of its top surface having external threads 14 interrupted by alignment grooves 13, depth graduations 16, multiple fully circular bushing holes 18, and multiple semi-circular edge notches 22. The circular bushing holes are located on a circle having a radius termed the Hole Radius.

The Multiguide top plate 28 has multiple bushing holes 18 that match those in the bottom plate in both size and location. A collar 30 is integrally formed with the top plate and has external threads 32 that engage the double nut 34 shown above the shaft.

The double nut has an upper set of internal threads that engage the shaft threads 14 and a lower set of internal threads that engage the collar connecting threads 32.

A centering pin 24 is shown directly below the center of the bottom plate that can be installed in a threaded hole in the bottom surface of the bottom plate. Two index pins 26 are shown spaced apart from the center pin by the Hole Radius. The pins are spaced apart from each other by a constant angular distance. The threaded end of the index pins can be installed in threaded index holes 20 in the bottom plate that surround the shaft 12.

No centering pin or index pins are installed if the Multiguide is to be used to align drill holes in flat working surfaces. Two index pins 26 are installed in the Multiguide when the Multiguide is to be used with the canting base or dowel jig attachments. The centering pin 24 is installed in a threaded hole in the center of the bottom face of the Multiguide if it is to be used with the dowel jig. The centering pin is replaced with a connecting bolt (not shown in this view) if the Multiguide is to be attached to the canting base.

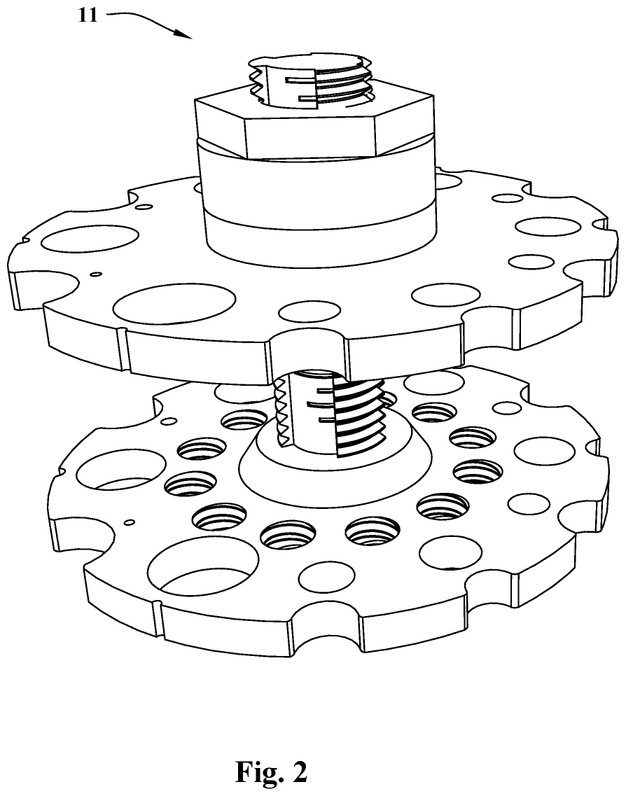

FIG. 2 shows a top-isometric view of the assembled Multiguide 11. All three major components seen in this view (bottom plate, top plate, and double nut) move as a unit when the double nut is secured to the shaft and top plate.

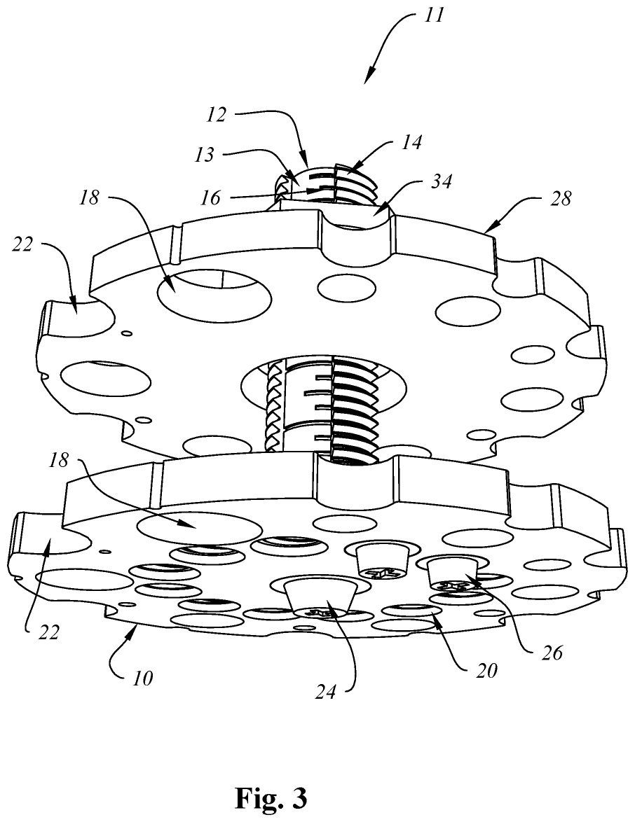

FIG. 3 shows a bottom-isometric view of the assembled Multiguide 11. The top plate 28 is slidingly connected to the shaft 12 and secured in position by the double nut 34. Shaft threads 14 are seen interrupted by alignment grooves 13. Depth graduations 16 are visible in a shaft groove. The centering pin 24 is seen installed in the center of the bottom plate 10. A multiplicity of index pin holes 20 are formed in the bottom of the bottom plate. Two index pins 26 are installed in two threaded index pin holes 20 in the bottom surface of the bottom plate 10. Bushings 18 and semi-circular edge notches 22 are also formed in both plates.

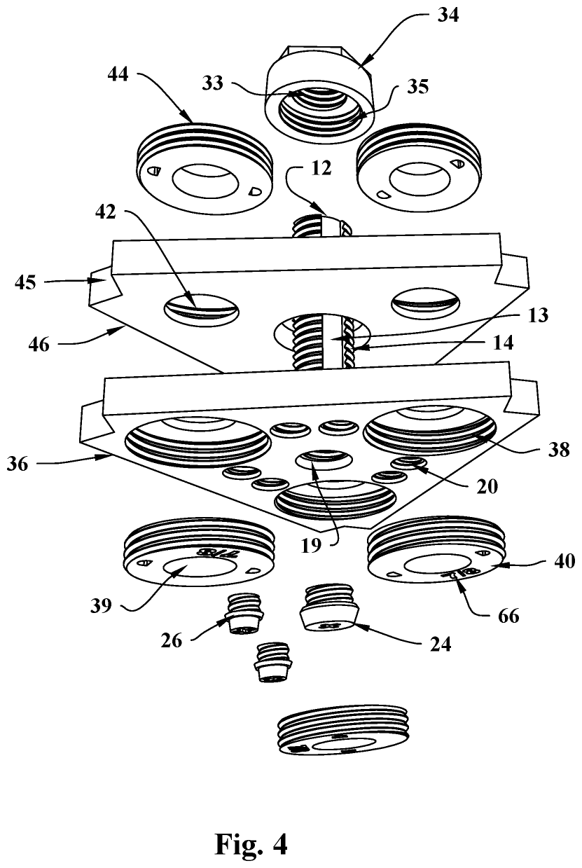

FIG. 4 shows a vertically exploded isometric view of the Triguide which has a bottom plate 36, top plate 46, double nut 34, three upper bushing inserts 44, and three lower bushing inserts 40. The top Triguide plate is slidingly connected to the shaft 12 that is rigidly attached to the bottom plate and has external threads 14 interrupted by alignment grooves 13. The same shaft 12 used on the Multiguide can be used on the Triguide.

The double nut 34 has internal shaft threads 33 and collar threads 35. The double nut secures the top plate 46 to the shaft 12 when the double nut is threaded onto the collar of the top plate (not visible in this view).

Three threaded lower bushing insert holes 38 are formed in the bottom surface of the bottom plate. Each such threaded hole receives a threaded lower bushing insert 40. Likewise, three threaded upper bushing insert holes 42 are formed in the top surface of the top plate 46 that receive a threaded upper bushing insert 44. Triangular edge notches 45 are formed at each apex of both the top and bottom Triguide plates that serve as partial bushings for drilling tools having long, thin shanks.

A threaded centering pin hole 19 is formed at the center of the bottom surface of the bottom plate. Three pairs of threaded index pin holes 20 are formed in the bottom surface of the Triguide bottom plate at a constant radial distance from the shaft (Hole Radius). Each pair of index pin holes in this embodiment is paired with the threaded lower bushing insert hole 38 located on the opposite side of the shaft. Each bushing insert (40 and 44) has a bushing 39 and a size label 66. Two index pins 26 and a center pin 24 can be seen installed in the bottom plate.

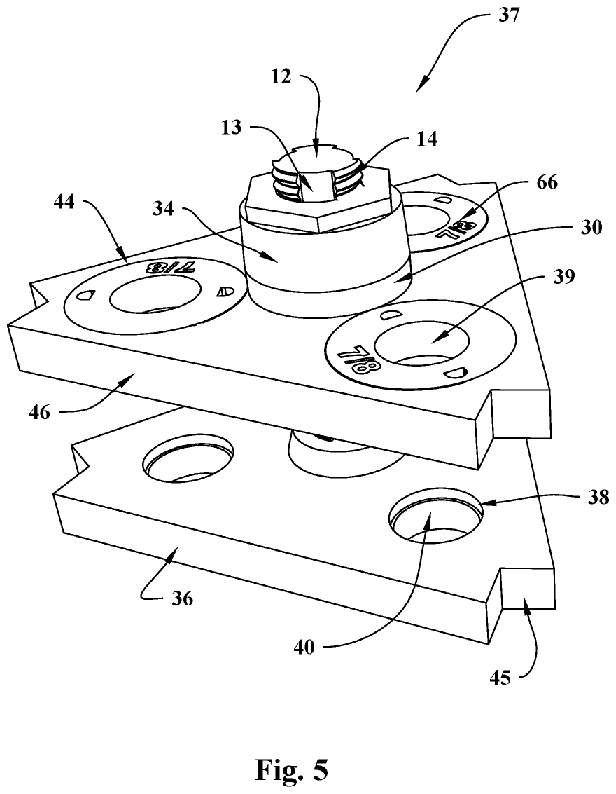

FIG. 5 shows a top view of the assembled Triguide 37. The shaft 12, Triguide top plate 46, Triguide bottom plate 36, upper bushing inserts 44, and bushing hole 39 are visible in this view. The bushing size is indicated by a bushing size label 66. Three lower bushing inserts are installed in three lower bushing insert holes 38. Three threaded upper bushing inserts are installed in three upper bushings holes the top plate. A triangular edge notch 45 is formed at each apex of the two plates. The double nut 34 secures the top plate to the collar 30 and shaft 12. An alignment groove 13 and shaft threads 14 are also visible.

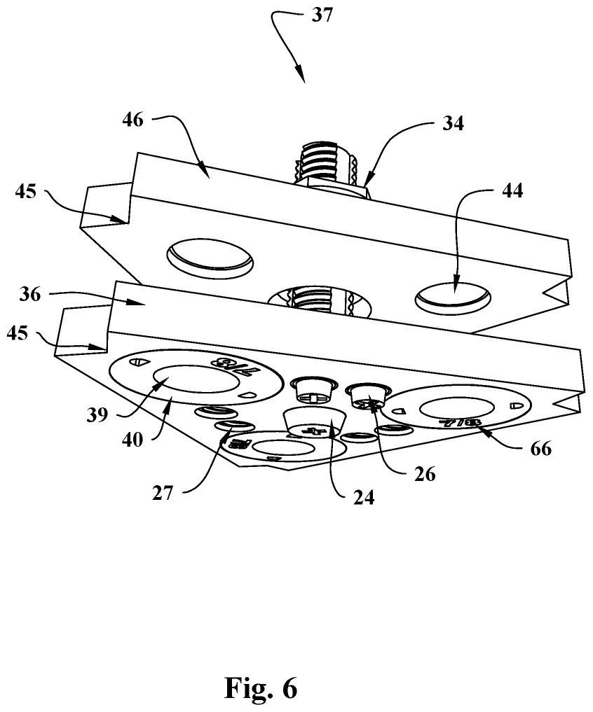

FIG. 6 shows the assembled Triguide 37 as viewed from below. Three lower bushing inserts 40, a pair of index pins 26, and one centering pin 24 can be seen installed in the corresponding threaded holes. Edge notches 45 serve as partial bushings for drilling tools having long, thin shanks. Three different bushing sizes can be installed at one time.

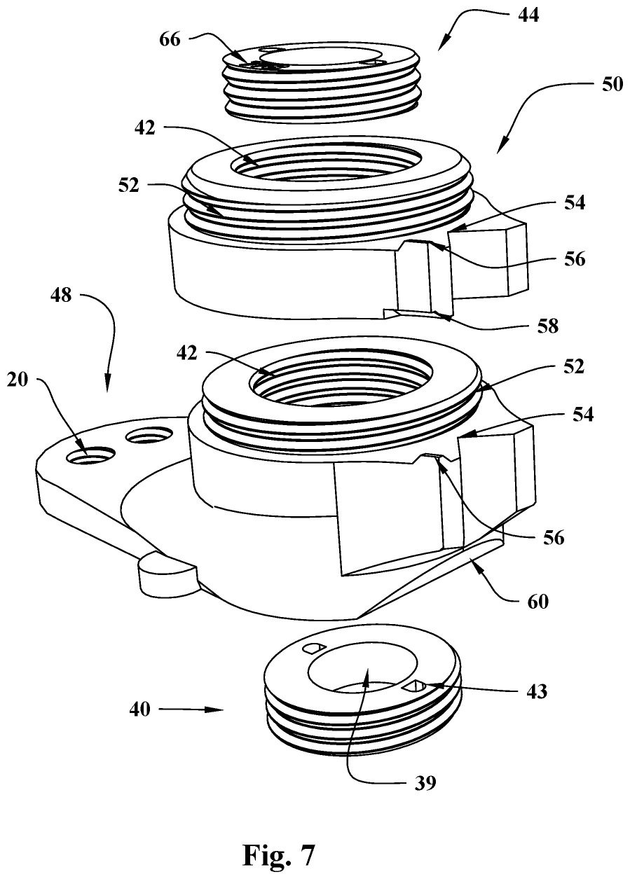

FIG. 7 shows an exploded view of a Uniguide assembly that is composed of a Uniguide body 48, one segment 50, an upper threaded bushing insert 44, and one lower threaded bushing insert 40. The Uniguide body can be used with no segments or with many segments. This view shows that the Uniguide body has external connecting threads 52, a threaded upper bushing insert hole 42, two threaded index pin holes 20, a Uniguide edge notch 54, a stop block 56, and a beveled face 60.

Each segment 50 has a threaded upper bushing insert hole 42, an edge notch 54, a stop block 56, and a stop block recess 58.

A threaded upper bushing insert 44 can be installed in either the top-most segment or, if no segments are installed, the Uniguide body. A threaded lower bushing insert 40 is installed in the threaded hole in the bottom of the Uniguide body in all cases. Two bushing rotation tool holes 43 are formed in each bushing insert, and a bushing size label 66 is formed on each face of each bushing insert.

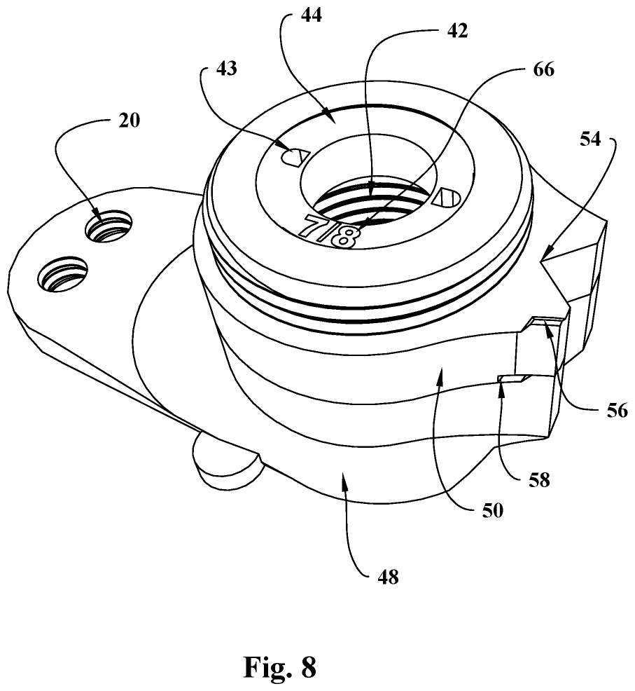

FIG. 8 shows a top isometric view of a Uniguide assembly. The upper bushing insert 44 is installed in the upper bushing insert hole 42 in the segment 50 or the Uniguide body 48 so that the desired hole depth is achieved when the drill chuck meets the upper bushing insert. The bushing size label 66 is marked on each bushing insert. In this embodiment, two bushing rotation tool holes 43 allow users to rotate the bushing insert using, for instance, a needle nose pliers. Users must overcome come friction between the bushing insert and either the segment or the Uniguide body to rotate the bushing.

A stop block 56 and stop block recesses 58 force proper alignment of the edge notches 54. Two threaded index pin holes 20 are visible in the Uniguide body.

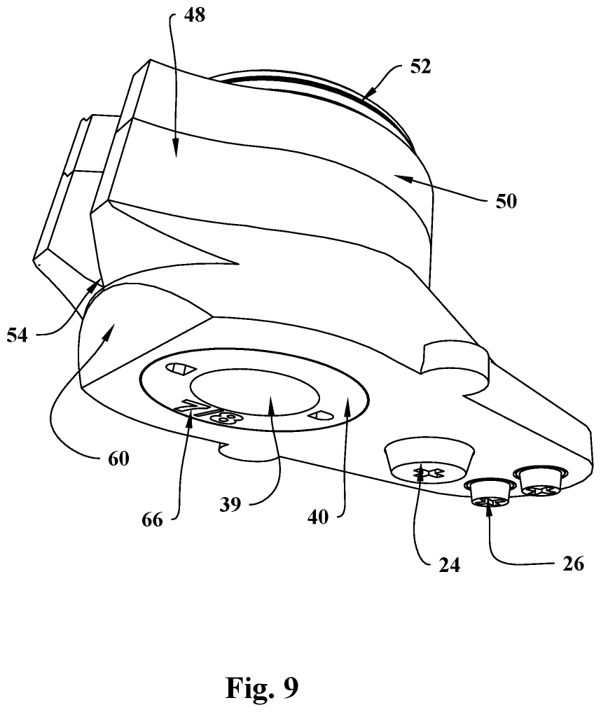

FIG. 9 shows a bottom isometric view of a Uniguide body 48 with one segment 50 optionally added forming an assembly. A threaded lower bushing insert 40 is shown installed in the bottom of the Uniguide body. When installed fully into the threaded hole, the bottom face of the lower bushing insert is flush with the bottom face of the Uniguide body.

A beveled face 60 allows the Uniguide body and canting base attachment to rotate without undue restriction. The centering pin 24 and two index pins 26 are installed in the corresponding threaded holes in the bottom face of the Uniguide body. When properly assembled, notches 54 in the Uniguide body and segments align. Multiple segments can be added via the external connector threads 52.

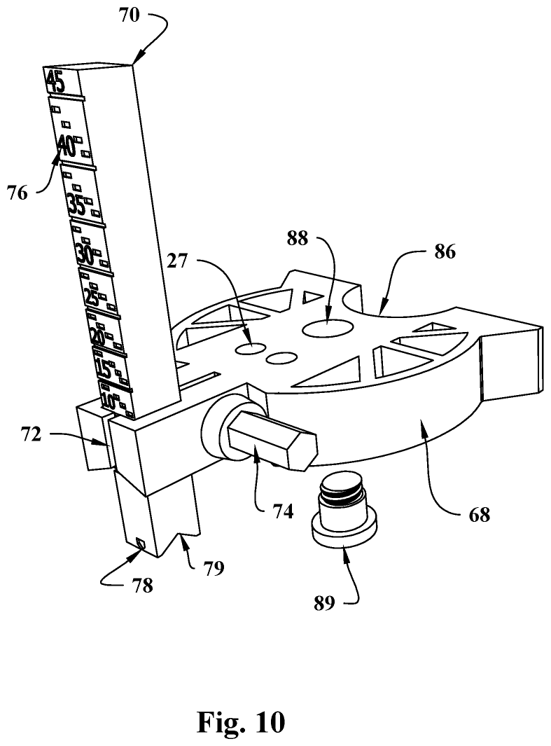

FIG. 10 shows a top-rear isometric view of the canting base attachment 68 with a canting shaft 70 secured in the canting base shaft slot 72 by the canting base clamp 74. Angle graduations 76 are marked on the canting shaft that can be used when drilling into flat working surfaces.

A canting base shaft center point 78 formed in the bottom end of the canting shaft can be used when drilling into flat surfaces to aid in aligning the canting base. The canting shaft will be installed in the canting base slot with angle graduations facing to the left or right rather than the rear when drilling into cylinders. The canting base cylinder shaft notch 79 aids in aligning the canting base on cylinders.

A canting base bolt hole 88 fully penetrates the canting base attachment at its center. A canting base bolt 89 is shown directly below the bolt hole. Two index pin recesses 27 are formed in the top surface of the canting base. A drill bit recess 86 is formed in the front face of the canting base attachment.

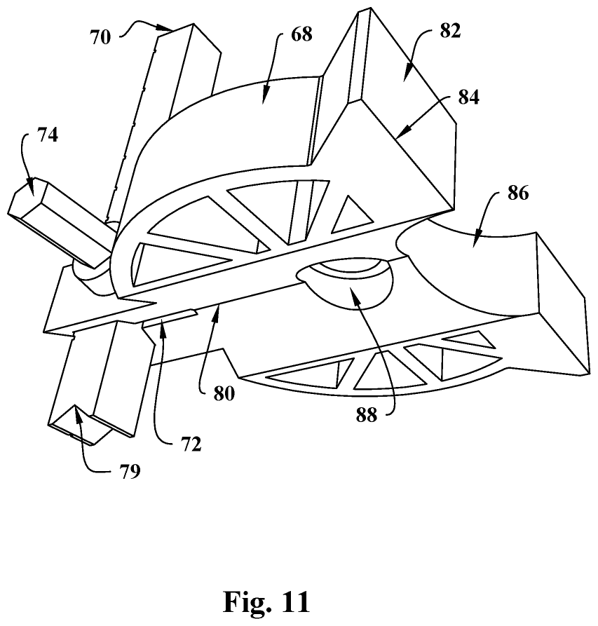

FIG. 11 shows a bottom-front isometric view of the canting base attachment 68. The canting base groove 80 and the canting base bolt hole 88 are visible in the bottom surface of the canting base. The canting base pivot edge 84 is visible at the bottom of the front face 82. The canting base shaft slot 72 is also visible at the apex of the groove. The shaft 70 can move up and down in the slot except when the clamp 74 is tightened. The drill bit recess 86 is visible at the front end of the canting base. The canting base shaft cylinder notch 79 conforms the attachment to cylinders when the shaft is rotated 90° in the slot so that angle graduations face to the left or right side of the attachment.

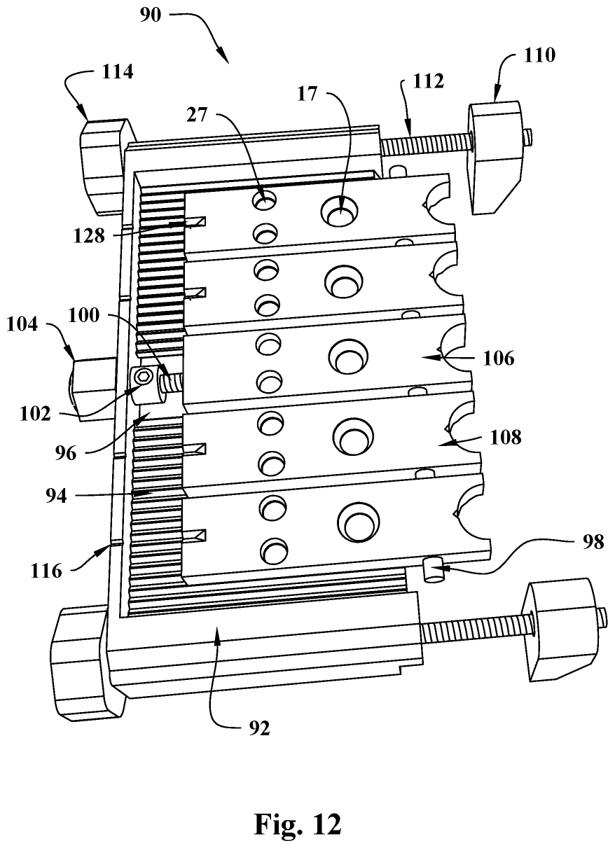

FIG. 12 shows a top isometric view of the dowel jig assembly 90 that includes the dowel jig body 92, center sliding block 106, and four outboard sliding blocks 108 as shown in this embodiment. The center sliding block slides forward and back within the center sliding block groove 96 formed in the top surface of the dowel jig body. The outboard sliding blocks move forward and backward on the dowel jig alignment grooves 94 that engage grooves in the bottom surface of the outboard sliding blocks. These alignment grooves prevent lateral movement of outboard sliding blocks and insure graduated spacings.

All sliding blocks are held in fore-and-aft position by a threaded position rod 100 and a sliding block locking rod 98.

The threaded position rod 100 is operated by turning a sliding block position control knob 104 acting against the back wall of the dowel jig body and a locking collar with set screw 102. A pair of threaded dowel jig clamp rods 112, dowel jig clamps 110, and dowel jig clamp knobs 114 are used to secure the dowel jig body to work pieces.

A centering pin recess 17 and two index pin recesses 27 are formed in the top surface of each sliding block. A sliding block center mark 128 is formed in the center of the back edge of each outboard sliding block. Standard spacing index notches 116 are formed in the back wall of the dowel jig body that align with the sliding block center marks when using standard spacings.

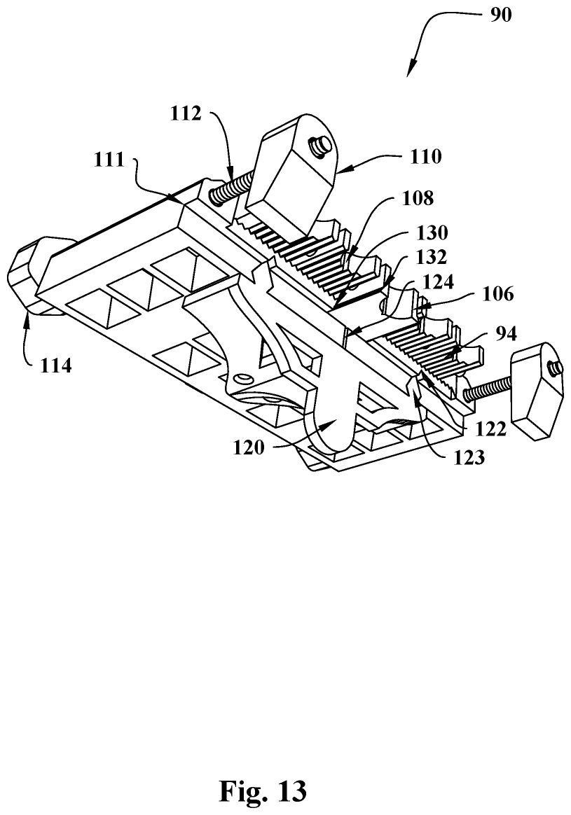

FIG. 13 shows a bottom isometric view of the dowel jig assembly 90 with the dowel jig brace 120 that is attached when drilling dowel holes into edges of work pieces. The dowel jig alignment edge 111 is visible near the front edge of the dowel jig body. The center sliding block 106 is seen to have a flat bottom surface while the outboard sliding blocks 108 have grooved bottom surfaces. A dowel jig center mark 124 is seen on the front face of the dowel jig body beneath the center sliding block. Dowel jig alignment grooves 94 are visible on the bottom side of the outboard sliding blocks.

Dowel jig engagement fittings 123 on the top surface of the dowel jig brace 120 slide into dowel jig brace engagement slots 122 formed in the bottom of the dowel jig body. A center sliding block flange groove 130 is formed on both sides of the dowel jig center groove 124. Center sliding block flanges 132 formed on the long bottom edges of the center sliding block engage the sliding block flange grooves and prevent upward and downward movement of the center sliding block.

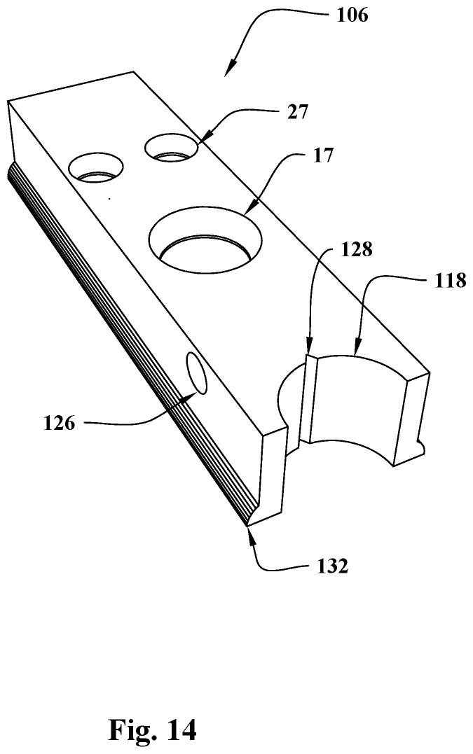

FIG. 14 shows a top-front view of a center sliding block 106. A center sliding block flange 132 is formed on each long bottom edge of the center sliding block. A sliding block locking rod hole 126 passes laterally through all sliding blocks. A centering pin recess 17 is formed on the axial center line at a specified distance from the front face each sliding block. Two index pin recesses 27 are shown in the top surface of each sliding block in this embodiment. Likewise, a center pin recess 17 is also visible in the center of each sliding block. A sliding block center mark 128 is formed in the rim of the dowel jig drill bit recess 18 at the longitudinal center of each sliding block. The intersection of a vertical plane passing through the longitudinal center of the sliding block and a second vertical plane passing through the front face of the sliding block marks the drill bit location.

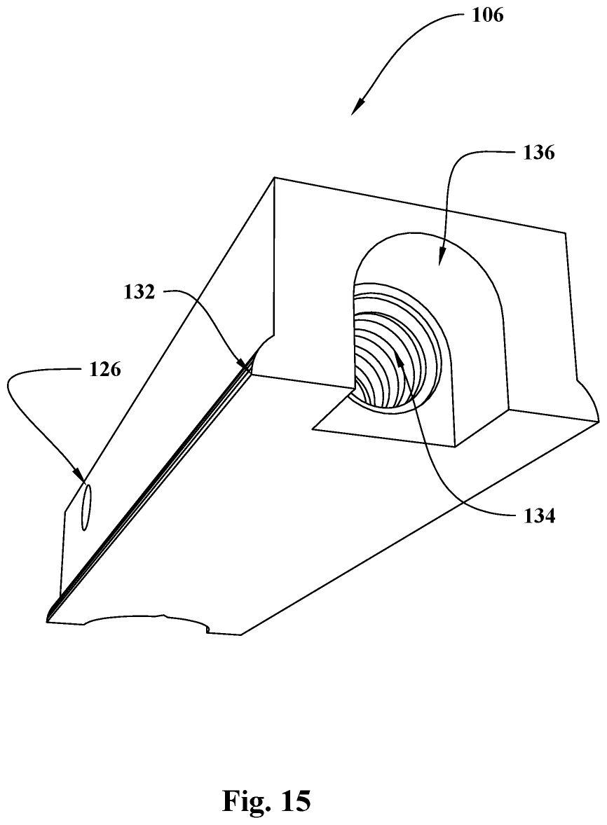

FIG. 15 shows a bottom-rear isometric view of a center sliding block 106. A locking collar recess 136 is formed in the rear of the center sliding block that allows the sliding block to pass over the locking collar (102 seen in FIG. 12). A threaded position control rod hole 134 extends through much of the center sliding block. Two center block flanges 132 and a sliding block locking rod hole 126 are also visible in this view. The base of the center sliding block is smooth.

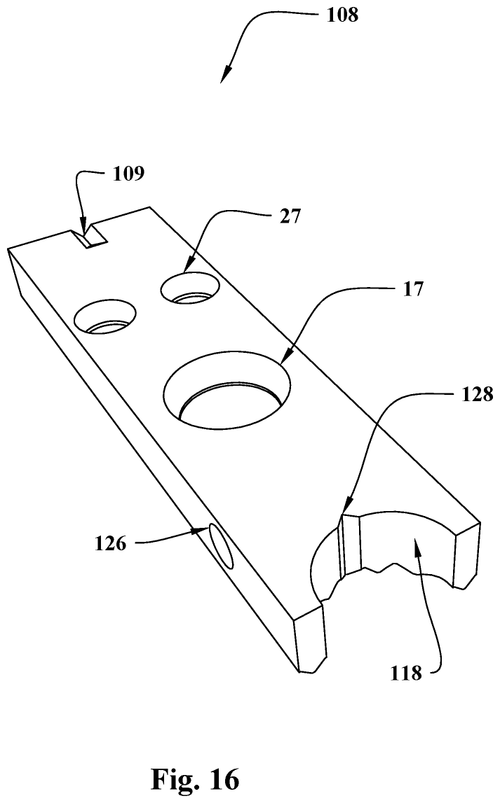

FIG. 16 shows a front-top isometric view of an outboard sliding block 108. A center pin recess 17, two index pin recesses 27, and a center notch 109 are formed in the top surface of the outboard sliding blocks. A locking rod hole 126 passes laterally through all sliding blocks. A dowel jig drill bit recess 118 and a center mark 128 are formed at the front end of each outboard sliding block.

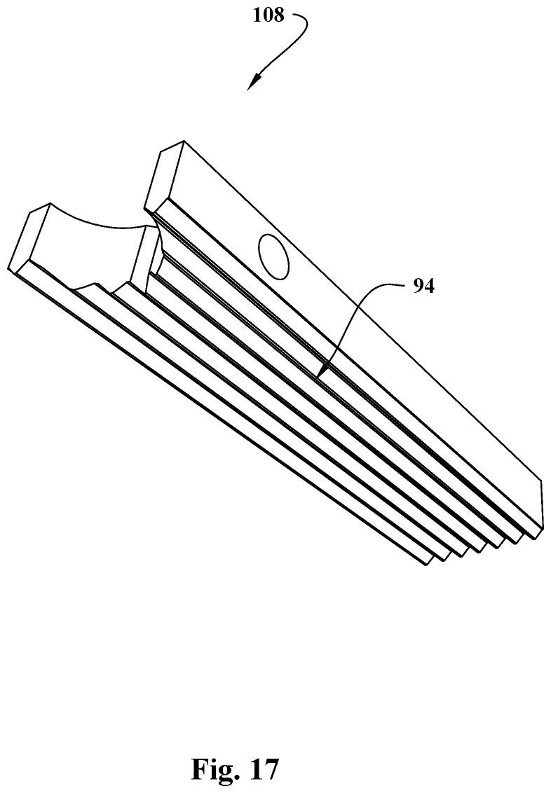

FIG. 17 shows a bottom isometric view of an outboard sliding block 108. Alignment grooves 94 are formed in the bottom surface of each outboard sliding block.

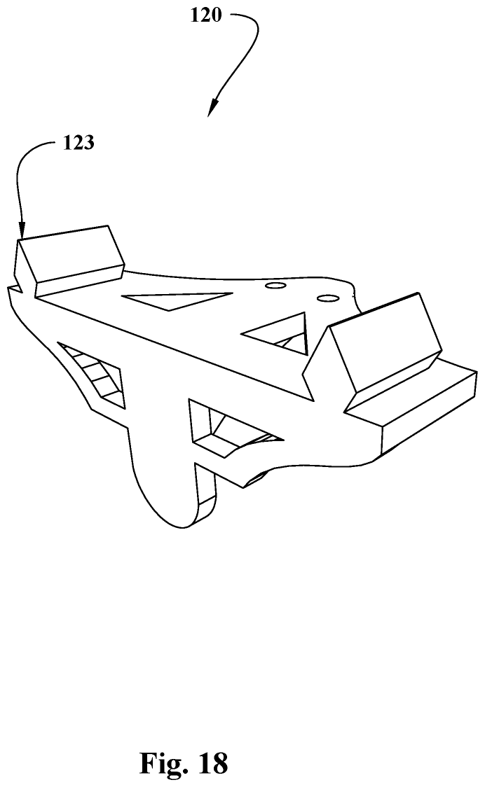

FIG. 18 shows a top-front isometric view of a dowel jig brace 120. Two dowel jig engagement fittings 123 project from the top surface of the brace. These fittings slide into dowel jig engagement slots (122 in FIG. 13). When the fittings are fully inserted into the engagement slots, the front face of the brace meets the dowel jig alignment edge (111 in FIG. 13).

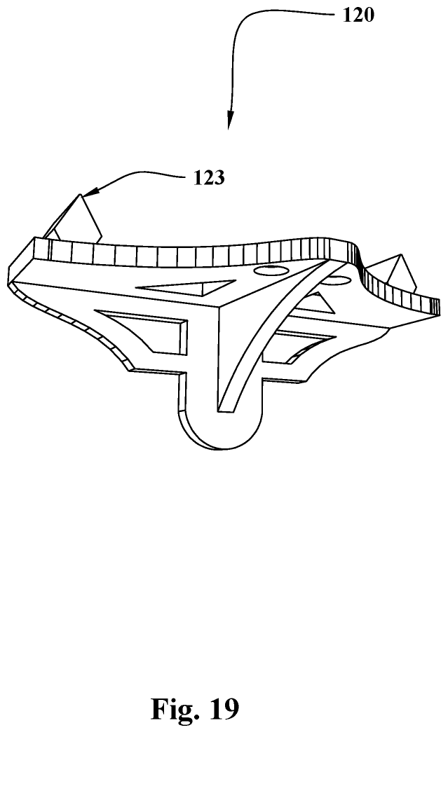

FIG. 19 shows a bottom-rear view of the dowel jig brace 120. The rear side of the dowel jig engagement fittings 123 are visible in this view. In this embodiment, the single gusset supports the two plates that form the brace. External clamps can bear upon the plate adjacent to and below the gusset plate.

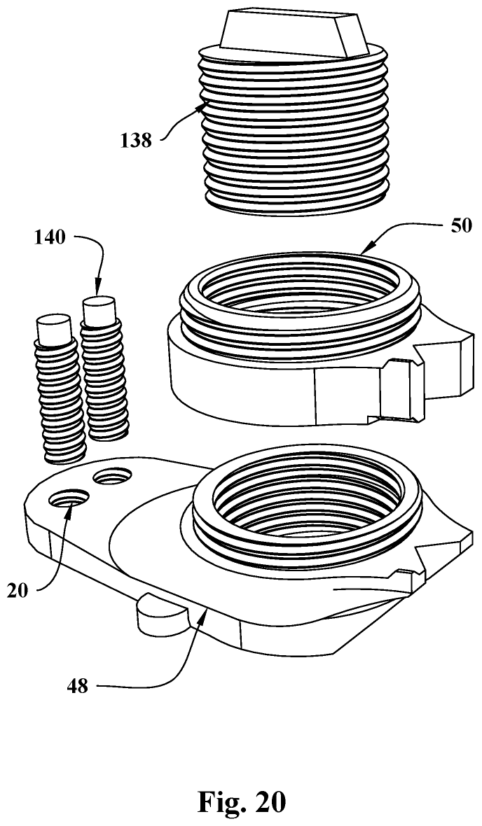

FIG. 20 shows an exploded view of the Uniguide body 48 with a threaded lifter shaft 138 in place of the two bushing inserts, and two Uniguide lifting bolts 140 that can be installed in the threaded index pin poles 20.

### DESCRIPTION OF OPERATION

### Multiguide

The Multiguide invention disclosed in this continuation-in-part application operates exactly like the drill guide disclosed in the parent application when no pins are installed in the bottom face of the bottom plate. When drilling non-inclined holes into flat work pieces using drilling tools having shanks and bits of the same diameter, the Multiguide is composed only of a bottom plate (with integral shaft), top plate (with integral threaded collar), and double nut. The top plate slidingly connects to the shaft attached to the bottom plate, and thus can be freely moved up and down the shaft. Users secure the drill bit of the proper size in a drill chuck, select the bushing of the proper size, insert the bit in the selected bushing, lower the assembly to the working surface, then measure the distance between the top plate and the bottom of the drill chuck. This distance is called the “stickup”. Users then lower or raise the top plate until the stickup equals the planned hole depth and secure the top plate in position by rotating the double nut until it fully engages the collar threads. This method of depth adjustment is called the “stickup method”.

Users can also hold the Multiguide away from the workpiece, insert the drill bit into the selected bushing until the drill chuck contacts the top plate, then measure the length of bit protruding beyond the base plate (L). Users subtract the desired hole depth (D) from L to obtain the necessary top plate movement (S) that will produce the desired hole depth D. Users slide the top plate the distance S, then secure the top plate in position by rotating the double nut until it fully engages the collar threads. Users can insert the drill bit into the selected bushing again and verify that the correct hole depth will be produced. Users place the drill bit at the selected hole location, lower the Multiguide to the working surface, then drill the hole until the drill chuck contacts the top plate.

### Triguide

Bushing inserts of the right size must be installed in the appropriate threaded holes in each plate of the Triguide before it can be used to align drilling tools and limit the depth of drilling. Once these inserts are installed, the Triguide is operated exactly like the original drill guide and Multiguide when drilling non-inclined holes into flat working surfaces.

Like the original drill guide and Multiguide, the Triguide can be set up for just one proper hole depth at a time. However, shallower pilot holes can be drilled using a separate drill and a bit that does not extend beyond the maximum planned depth.

### Uniguide

The Uniguide can service only one bushing size at a time. One or more segments must be added to the Uniguide body if the planned hole depth cannot be accommodated using just the Uniguide body. Users install a bottom bushing insert in the bottom of the Uniguide body. When properly installed, the bottom surface of the bushing insert will be flush with the bottom surface of the Uniguide body, and the size label will be visible. Users can rotate the bushing inserts using the bushing rotation tool holes 43 using, for example, a needle-nose pliers.

Users install a top bushing insert in the top of the Uniguide body or, if one or more segments is attached to the body, the top-most segment. Users adjust the stickup by rotating the top bushing insert until the stickup distance matches the planned hole depth as previously described.

### Canting Base Attachment

Two index pins must be installed in the bottom surface of the Multiguide, Triguide, and Uniguide when them with the new canting base attachment. In the case of the Multiguide and Triguide, an index pin must be installed in each of two threaded index pin holes on the opposite side of the centering pin hole from the selected bushing. The Uniguide has only two threaded index pin holes that can receive index pins, so users simply install an index pin in each threaded index pin hole. Each drill guide is placed on the canting base attachment so that both index pins protruding from its base fall within matching recesses in the top surface of the new canting base. Users then connect the canting base to the drill guide using a bolt that passes upward through the canting base into the threaded hole in the center of the base of each drill guide. The assembled drill guide and canting base attachment form a unit that users can hold and guide with just one hand. Additionally, the selected bushing pair will automatically align with the new canting base.

Users can remove the canting shaft from the canting base assembly when drilling non-inclined holes into flat working surfaces. Bushings are used to align drilling tools having bits and shanks of the same diameter. When using such drilling tools, users place the assembly on the working surface, lower the drill bit point through the bushings to that surface, measure the stickup distance, and adjust the depth of drilling using the stickup method.

Edge notches are used to align drilling tools, such as Forstner bits, having bits that are larger than their shanks. The drill bit recess in the front face of the canting base provides space for large diameter bits. When using such tools, users hold the shank against the selected notch and lower the bit to the working surface. Users can use the stickup method to adjust the depth of drilling using the stickup method when using the Multiguide or Triguide.

The Uniguide body and segments, by themselves, cannot be adjusted to provide infinite control of depth when using the edge notches. However, infinite depth control can be provided by replacing the two bushings with a threaded shaft and installing two long bolts in the index pin holes. These added elements allow the Uniguide body to be raised above the working surface by variable distances. The Uniguide can thus be used to drill holes to precise depths using, for example, Forstner bits. Depth adjustments can be made using the stickup method.

When drilling inclined holes into flat working surfaces, users install the canting shaft in the canting base shaft slot with canting angle graduations facing rearward. Canting angles can be set by lowering the shaft until the selected angle graduation aligns with the top surface of the canting base. Once properly positioned, the canting shaft can be secured using the integral clamp. Users can adjust the canting angle more precisely using, for example, a bevel square. This is especially useful when the selected angle does not coincide with an angle graduation line.

Proper bit alignment for canted holes can be set by striking a line on the working surface that (1) is perpendicular to the plane through which the hole should pass and (2) passes through the marked hole location. Users place the canting base assembly on the working surface so that the drill bit point falls on the marked hole location and the pivot edge of the canting base aligns with the struck line. Users can adjust the assembly for drilling to the correct depth of drilling using the stickup method.

When drilling non-inclined holes in cylinders, users can remove the canting shaft from the canting base assembly. Users place the canting base assembly on the cylinder so that the groove in its base conforms to the cylinder. Users then adjust the assembly for hole depth using the stickup method. They place the assembly on the cylinder so that the drill bit point meets the marked hole location and advance the drill bit until the drill chuck meets the top bushing.

When drilling inclined holes in cylinders, angle graduations on the canting shaft cannot be used. The canting shaft must be installed in the canting base attachment with the angle graduations facing left or right rather than rearward. The canting base assembly (canting base and drill guide) should be placed on the cylinder so that the deep groove in the canting base conforms to the cylinder. Users must adjust the canting shaft until the top surface of the canting base is canted at the proper angle as measured externally. For example, a user can set a bevel square to the proper angle, then adjust the position of the canting shaft until the top surface of the canting base meets the blade of the bevel square when the bevel square is held against both the cylinder and canting base.

### Dowel Jig Attachment

Users can drill multiple equally spaced-apart and accurately aligned dowel holes to precise depths into the edges and faces of planar work pieces using a new drill guide and new dowel jig attachment disclosed in this continuation-in-part application. Dowel holes will be automatically aligned at constant distances from edges, evenly spaced apart by gauged distances, aligned perpendicular to work surfaces, and extended to precise depths.

In these embodiments disclosed in this continuation-in-part application, the dowel jig and index system combine to allow users to drill up to five evenly spaced and properly aligned dowel holes at one jig setup location in edges or faces of planar work surfaces. The jig's center and outboard sliding blocks move in unison. The center block slides within a wide, flat-bottomed central groove in the dowel jig. Central sliding block flange grooves are formed in the dowel jig at the bottom of the center sliding block groove. Flanges on the center sliding block engage these flange grooves and prevent vertical movement. Vertical movement of all outboard sliding blocks is also prevented because the locking rod passes through all sliding blocks including the center sliding block.

The outboard blocks have grooved bottom surfaces and slide on the grooved top surface of the dowel jig body. Outboard sliding blocks can be shifted left and right incrementally relative to the center sliding block providing numerous gauged spacing distances between dowel holes. This new dowel jig invention supports the use of standard dowel spacing intervals by providing spacing index notches on the back wall of the dowel jig body, center notches on the outboard sliding blocks, and compatible groove widths in the top surfaces of the dowel jig body. For example, one European standard spacing is 32 mm, and one US standard spacing is 1-¼ inch. This new dowel jig invention can support either of these standard spacings, but not simultaneously., and numerous non-standard spacings.

The front faces of the center and outboard sliding blocks are in the same plane as the drill bit and allow users to accurately position dowel holes at marked locations. This invention provides infinite control over position relative to the thickness of an edge, and numerous gauged spacing distances.

Users can mark a first dowel hole location on an edge of a work piece, then mark orthogonal lines through that point that are aligned parallel to the edge and perpendicular to the edge forming a large plus sign. A center finding tool can be used to locate the geometric center of an edge if the hole should be located at the center of the edge.

Users mark an additional point on the edge where a dowel hole will be drilled using the center sliding block. The plus sign at this location should extend to the face that the jig will be placed against. Users attach the dowel jig and brace to the work piece with the center line groove in the front face of the dowel jig lined up with the mark on the work piece.

Clamp knobs are then rotated until the jig is firmly secured to the work piece. Users rotate the position control rod until the front faces of the sliding blocks line up with the plus signs. The dowel jig is then properly positioned to drill dowel holes. Users adjust the depth of drilling using the stickup method.

If more than five dowel holes are to be drilled on a long edge, users can drill five holes at a first position, then move the dowel jig to a new position that aligns the left-most or right-most outboard sliding block with the last hole drilled. Users insert the drill bit in the left-most or right-most outboard sliding block, then insert the drill bit into the last hole drilled. Holding the bit in the drilled hole, users clamp the jig into position against the work piece. The dowel jig is then properly positioned to drill additional dowel holes. This process makes the dowel jig self-aligning.

When drilling holes in the faces of work pieces, users remove the brace from the dowel jig and mark a line on the work piece face that passes through the center of all planned dowel holes. Users mark the center of the dowel hole that will fall beneath the center sliding block. Two thin rectangular offset blocks having the same width (offset distance) are formed. The length of each offset block should be equal to its width plus the width of a sliding block. A rigid straight edge tool (standard) having the same thickness as the offset blocks is clamped to the face of the work piece with its long edge aligned parallel to the planned line of dowel holes, but offset from that line by the offset distance. That is, the long edges of the offset blocks should bear against the standard and align with the planned line of dowel holes. The two offset blocks are then repositioned so that their short edges bear against the standard. The two offset blocks are then clamped between the standard and dowel jig body using the integral dowel jig clamps. The sliding blocks can be moved using the position control rod on the dowel jig to align their front faces with the planned line of dowel holes. The dowel holes can then be drilled.

This new dowel jig has no need of sliding adapters; thus, users do not need to maintain a rearward acting force on the Multiguide, Triguide, or Uniguide while drilling dowel holes. This change reduces the risk that a dowel hole will be drilled in the wrong location and increases safety since the system is more stable. Additionally, the new dowel jig is thinner and has a lower parts count compared to the original dowel jig. Thus, the new dowel jig represents a betterment over the original dowel jig disclosed in the parent application.

### Other Embodiments

No new embodiments beyond those disclosed in this continuation-in-part application are known. However, it is possible to eliminate one index pin from the new embodiments. In that case, the single index pin would be placed in alignment with the corresponding bushing. Two index pins were used in the drill guide disclosed in the parent application to reduce plate diameter. Additionally, if a user loses one index pin, the second index pin will suffice. If only one index pin hole is provided, and the user loses the single index pin, then the tools cannot be aligned with the attachments. Thus, providing two index pins provides some redundancy. However, care must be taken to insure that the single index pin falls within the correct index pin recess.

### Method of Manufacture

These inventions, save metal bushings, rods, inserts, nuts, and other small components, can be largely composed of plastic and produced using injection molding techniques. Some limited post-injection processing may be required for the attachments. For example, it might be desirable to install hollow, cylindrical metal inserts having external and internal threads in holes formed in plastic components that will engage threaded metal rods.

Thin metal plates having the same fully circular bushing holes and semi-circular edge notches as those produced in plastic top and bottom plates of the Multiguide and Triguide, but slightly undersized, can be incorporated into the production of parts produced using injection molding techniques. These metal plates might be placed into the injection mold before injection takes place. Threaded index pin holes and centering pin holes can be formed in the bottom plate using retractable threaded shafts mounted in the molding machine. It may also be possible to form the threaded holes by tapping holes drilled in the plates if suitable plastic materials are used to form the plates. Alternatively, metal plates might be affixed to the top and bottom plates after injection using a thermal and/or mechanical process.

Plastic used in injection molding processes should have high strength, hardness, and a high melting temperature. Thermoset plastics do not change shape when heated to moderate temperatures that might be produced by hot bits.

The Multiguide, Triguide, and Uniguide can also be formed using ceramic materials for little cost that have high durability and are non-conductive. These drill guides can also be produced using mostly metal components. The shaft might be formed on a lathe or NRC machine, then welded to the bottom plate. In this way, a more durable drill guide can be produced.

Both the canting base attachment and dowel jig can be produced using injection molding techniques.

Busing inserts will invariably be produced using metal unless more competent plastic materials become available. It is desirable that the bushing inserts be installed within plastic drill guides so that friction between the insert and drill guide can maintain the inserts in their proper position. Alternative methods of holding bushing inserts in position can be employed that involve a mechanical device such as a screw or spring.

What is claimed is:

1. A system comprised of a drill guide (bottom plate with integral threaded shaft, top plate, and locking nut), a threaded centering pin, a multiplicity of threaded index pins, and a multiplicity of attachments.

2. A system according to claim 1, said bottom plate having a threaded centering pin hole at its center that can receive a replaceable threaded centering pin that centers the drill guide on attachments.

3. A system according to claim 2, said centering pin hole having a shallow rim groove.

4. A system according to claim 1, said centering pin comprising a threaded shaft, a shoulder section conforming to the shallow rim groove surrounding the centering pin hole in the bottom face of the bottom plate, and a shaped centering pin head.

5. A system according to claim 4, said shaped centering pin head having a recess that conforms to the head of a screwdriver.

6. A system according to claim 1, said bottom plate having a multiplicity of threaded index pin holes arranged at regular intervals around the centering pin hole that can receive replaceable threaded index pins that align the drill guide on attachments.

7. A system according to claim 6, said threaded index pin holes being surrounded by a shallow rim groove.

8. A system according to claim 1, said threaded index pins comprising a threaded shaft, a shoulder section conforming to the shallow rim grooves surrounding index pin holes in the bottom face of the bottom plate, and a shaped index pin head.

9. A system according to claim 8, said shaped index pin head having a recess that conforms to the head of a screwdriver.

10. A system comprised of a drill guide (bottom plate with integral threaded shaft, top plate, and locking nut) and multiple pairs of replaceable bushing inserts of various sizes that can be installed in threaded holes in drill guide top and bottom plates that serve to align drilling tools and limit drilling depth.

11. A drill guide comprised of a body having a small footprint that includes just one pair of replaceable threaded bushing inserts that serves to align drilling tools and limit drilling depths.

12. A system according to claim 11, the drill guide body having an integral notched projection that serves to align drilling tools having bits that are larger than their shanks.

13. A system according to claim 11, said drill guide body optionally having segments with integral notched projections attached to it that increase the length of drilling tools that can be accommodated.

14. A system according to claim 11, said drill guide having a threaded raising shaft installed in place of two bushing inserts, and raising bolts installed in place of threaded index pins that serve to raise the drill guide body above working surfaces by infinitesimally small amounts when using drilling tools having bits that are larger than their shanks.

15. A system according to claim 14, said raising shaft having a centering pin recess that can receive a threaded centering pin in its base.

16. A system according to claim 14, said raising bolts having an integral index pin head at their bottom ends.

17. A system comprised of a drill guide, canting base attachment, one or two threaded index pins, and a connecting bolt that aids in the drilling of canted and non-canted holes in flat and cylindrical working surfaces using drilling tools have bits and shanks of various sizes.

18. A system according to claim 17, said canting base attachment having a through hole and a concentric partially penetrating hole at its center that pass through the large groove in the bottom surface of the canting base attachment.

19. A system according to claim 17, said bolt can secure the canting base attachment to a drill guide forming a unit that users can control using just one hand.

20. A system according to claim 17, said canting base attachment having one or two index pin recesses that conform in size, shape, and location to the index pin heads installed in a drill guide.

21. A system according to claim 17, said canting base attachment having a canting shaft installed in an integral fixture that can be raised and lowered to cant drilling tools.

22. A system according to claim 21, said canting shaft having a V-shaped groove at its tip that is aligned parallel to angle graduation lines that serves to align the canting base with cylinders.

23. A system comprised of a drill guide, replaceable threaded centering pin, a multiplicity of replaceable threaded index pins, and a dowel jig.

24. A system according to claim 23, said the dowel jig being composed of a body, a center sliding block, a multiplicity of outboard sliding blocks, two clamp mechanisms, a position control rod, a locking collar with set screw, and a locking rod.

25. A system according to claim 23, said center sliding block and outboard sliding blocks having a center pin recess and multiple index pin recesses.

26. A system according to claim 23, said drill guide and dowel jig moving without slippage or misalignment because the drill guide is held firmly in position by replaceable threaded centering and index pins installed in its base that fall within conforming recesses in the sliding blocks.

27. A system according to claim 23, the dowel jig attachment having sliding blocks that have no need of adapters.

28. A system according to claim 23, the dowel jig attachment optionally having a brace that can support multiple exterior clamps.
